(19) United States
(12) Patent Application Publication
(10) Pub. No.: US 2026/0187528 A1
(43) Pub. Date: Jul. 2, 2026

(54) Personalized federated learning method and system based on similar feature collaboration

(71) Applicants: ZHEJIANG UNIVERSITY, Hangzhou (CN); BINJIANG INSTITUTE OF ZHEJIANG UNIVERSITY, Hangzhou (CN)

(72) Inventors: Gang Yu, Hangzhou (CN); Bo Lin, Hangzhou (CN); Jing Wang, Hangzhou (CN); Jing Li, Hangzhou (CN); Jian Huang, Hangzhou (CN); Jianwei Yin, Hangzhou (CN)

(73) Assignees: ZHEJIANG UNIVERSITY, Hangzhou (CN); BINJIANG INSTITUTE OF ZHEJIANG UNIVERSITY, Hangzhou (CN)

(21) Appl. No.: 19/155,900

(22) PCT Filed: Dec. 15, 2023
(86) PCT No.: PCT/CN2023/139130

§ 371 Date: Aug. 12, 2025

(30) Foreign Application Priority Data
Feb. 13, 2023 (CN) 202310104418.6

(51) Int. Cl. G06N 20/00

(52) U.S. Cl. CPC G06N 20/00

(57) ABSTRACT

The present invention provides discloses a personalized federated learning method and system based on similar feature collaboration, applied to clients and servers, wherein each of the servers is used to manage at least two of the clients, each of the client has a local model and a local data set; the method comprises: (1) the servers receives local class-level feature vector sets sent by the clients; (2) the servers generate personalized class-level feature vector sets for the clients based on aggregation weights of the clients according to the local class-level feature vector sets; (3) the clients download corresponding personalized class-level feature vector sets from the servers, train and update local models on local data sets thereof, and obtain local class-level feature vector sets; and (4) the steps (2) to (3) are repeated until average training losses of the clients no longer decrease.

### TECHNICAL FIELD

The present invention relates to the field of federated learning technology, and in particular to a personalized federated learning method based on similar feature collaboration and a personalized federated learning system based on similar feature collaboration.

### BACKGROUND TECHNOLOGY

Federated Learning (FL) is essentially a distributed machine learning framework that enables data sharing and collaborative modeling while ensuring data privacy, security, and legal compliance. The core concept of federated learning is that when multiple data sources participate in model training, joint model training is performed solely through the interaction of intermediate model parameters, without requiring the transfer of raw data. The original data does not need to be stored locally.

Due to the heterogeneity of data and models, traditional FL still faces some practical challenges, and effective algorithms suitable for overcoming these two challenges have not been fully developed or systematically studied. Existing solutions to the data heterogeneity problem include: (1) assigning and maintaining multiple global models to different local clients, such as clustered FL; (2) utilizing global and local information to generate personalized models for each client, such as personalized FL. Most of these methods rely on gradient-based aggregation, resulting in high communication costs and heavy reliance on local models with the same structure. Model heterogeneity is common because different clients have different hardware and computing capabilities. Knowledge distillation-based FL solves this problem by transferring the knowledge of the teacher model to student models with different model structures. However, these methods require an additional public dataset to align the outputs of the student and teacher models, which increases the computational cost. Moreover, the performance of the method will significantly degrade as the distribution difference between the public dataset and the client dataset increases.

Furthermore, clients participating in federated learning may have additional requirements beyond training useful FL models. For example, a pharmaceutical company may want to build a model that utilizes data from multiple hospitals through FL to facilitate drug research. To compensate participating hospitals, the pharmaceutical company may need to provide incentive payments.

Therefore, in the existing technology, how to solve the problem of local model performance degradation in federated learning in data heterogeneous scenarios, while taking into account model heterogeneity, communication costs and explainable participant contribution evaluation, is an urgent problem to be solved.

### SUMMARY OF THE INVENTION

The present invention provides a personalized federated learning method based on similar feature collaboration and a personalized federated learning system based on similar feature collaboration, which are designed to mitigate the degradation of local model performance caused by data heterogeneity between clients in federated learning, while also addressing issues such as model heterogeneity, communication costs, and interpretable participant contribution evaluation.

The present invention has following technical solutions:

A personalized federated learning method based on similar feature collaboration, characterized in being applied to clients and servers, wherein each of the servers is used to manage at least two clients, and each of the client runs a local model and a local data set for training the local model; and the method comprises:
(1) the servers initialize and receive local class-level feature vector sets sent by the clients;
(2) the servers generate personalized class-level feature vector sets for the clients based on aggregation weights of the clients according to the local class-level feature vector sets sent by the clients;
(3) the clients download corresponding personalized class-level feature vector sets from the servers, and update local models on local data sets thereof by minimizing sums of local classification errors and distances between the local class-level feature vector sets and the personalized class-level feature vector sets; updated local models obtain updated local class-level feature vector sets and send to the servers; and
(4) the steps (2) to (3) are repeated until average training losses of the clients no longer decrease.

A local data set on one of the clients is input into a local models thereof, output of one fully connected layers responsible for decision-making in a back end of classification network (such as a second-to-last fully connected layer) is used as a feature vector of a class of the client, and feature vectors of all data samples belonging to the class are averaged to obtain a local class-level feature vector of the class.

Typically, a classification model comprises two parts: a feature extraction part and a classification prediction part. The feature extraction part usually comprises convolutional layers and downsampling, the classification prediction part usually comprises fully connected layers, and output dimension of a last fully connected layer is the same as the number of classes. The present invention uses output of one fully connected layer responsible for decision-making in a back end of classification network (such as a second-to-last fully connected layer) as a feature vector of a class of the client. If multiple samples from the same client belong to the same class, the feature vectors of the class are averaged as the feature vector of the class, and the feature vector is defined as a local class-level feature vector. The number of local class-level feature vectors is equal to the number of classes a client has.

Output sizes of fully connected layers where the clients use to extract local class-level feature vectors are same. If the output sizes of fully connected layers used by the clients to extract the local class-level feature vectors are the same, the local classification model structures do not need to be exactly the same.

On the servers, the local class-level feature vectors of the clients with samples of the same class are aggregated based on aggregation weights of the clients to obtain personalized class-level feature vectors for the clients.

If multiple different clients all have samples of the same class, assuming that clients A, B, and C all have class 1, then take the client A as an example, the output obtained by rule-weighted aggregation of the local class-level feature vectors of class 1 for the clients A, B, and C is called the personalized class-level feature vector of class 1 for the client A. Similarly, personalized class-level feature vectors of class 1 for the clients B and C can be obtained.

The step (2) comprises:
(i) for a client i, calculating distances between a local class-level feature vector

$${C}_{i}^{( j )}$$

of a class j and a local class-level feature vector

$${C}_{k}^{( j )}$$

on other clients containing the class

$$j , {dist}_{i , k}^{( j )} , k ∈ [ 1 , {M}^{( j )} ] ,$$

and obtaining a distance vector

$${dist}_{i}^{( j )} = [ {dist}_{i , 1}^{( j )} , … , {dist}_{i , i}^{( j )} , … , {dist}_{i , {M}^{( j )}}^{( j )} ] ,$$

where: j∈[1, |Cᵢ|], |Cᵢ| is number of classes on the client i; M^{(j)} represents number of clients containing the class j; and

$${dist}_{i , i}^{( j )}$$

is set to a constant, can be fixed (such as 1) or variable (such as 1 at the beginning and gradually decreases) during training and affects the proportion of the features of the client i itself, and the smaller the value, the greater the proportion;
(ii) for the distance vector

$${dist}_{i}^{( j )} ,$$

taking an inverse ratio of the distances

$${dist}_{i , k}^{( j )}$$

and normalizing to obtain a weight vector

$${S}_{i}^{( j )} = [ {S}_{i , 1}^{( j )} , … , {S}_{i , i}^{( j )} , … , {S}_{i , {M}^{( j )}}^{( j )} ] , where {s}_{i , k}^{( j )}$$

represents an aggregate weight of a client k for the class j of the client i, and

$${\sum }_{k = 1}^{{M}^{( j )}} {s}_{i , k}^{( j )} = 1 ;$$

(iii) calculating a personalized class-level feature vector

$${\tilde{C}}_{i}^{( j )}$$

for the class j on the client i via following calculation formula:

$${\tilde{C}}_{i}^{( j )} = {[ {s}_{i , 1}^{( j )} , … , {s}_{i , i}^{( j )} , … , {s}_{i , {M}^{( j )}}^{( j )} ] [ {C}_{1}^{( j )} , … , {C}_{i}^{( j )} , … , {C}_{{M}^{( j )}}^{( j )} ]}^{T} = {\sum }_{k ∈ {M}^{( j )}} {s}_{i , k}^{( j )} {C}_{k}^{( j )} .$$

In the step (i), the distances

$${dist}_{i , k}^{( j )}$$

comprise Euclidean distances, Manhattan distances, and angle cosine distances.

A formula for calculating the Euclidean distances is

$${dist}_{i , k}^{( j )} = \sqrt{{( {C}_{i}^{( j )} - {C}_{k}^{( j )} )}^{2}} , where k ∈ [ 1 , {M}^{( j )} ] ,$$

a formula for calculating the Manhattan distances is

$${dist}_{i , k}^{( j )} = \vert {C}_{i}^{( j )} - {C}_{k}^{( j )} \vert , where k ∈ [ 1 , {M}^{( j )} ] ;$$

and
a formula for calculating the angle cosine distances is

$${dist}_{i , k}^{( j )} = \frac{〈 {C}_{i}^{( j )} , {C}_{k}^{( j )} 〉}{\vert {C}_{i}^{( j )} \vert \vert {C}_{k}^{( j )} \vert} , where k ∈ [ 1 , {M}^{( j )} ] .$$

In the step (3), a local training loss Lᵢ of a client i is

$${L}_{i} = {L}_{S} ( {F}_{i} ( {w}_{i} , {x}_{i} ) , {y}_{i} ) + λ {\sum }_{j = 1}^{\vert {C}_{i} \vert} \frac{\vert {D}_{i , j} \vert}{{N}_{j}} {L}_{R} ( {C}_{i}^{( j )} - {\tilde{C}}_{i}^{( j )} ) ,$$

where wᵢ is parameter of a local model of the client i; xᵢ is an input data; yᵢ is a label corresponding to xᵢ; Fᵢ is classification prediction obtained after xᵢ is input into the local model; |Dᵢ| is number of local data of the client i; |D_{i,j}| is number of data containing a class j in the local data; N is total number of samples on the clients; Nⱼ is total number of samples belonging to the class j on the clients;

$${C}_{i}^{( j )} and {\tilde{C}}_{i}^{( j )}$$

are local class-level feature vector and personalized class-level feature vector of the class j on the client i, respectively; |Cᵢ| is number of classes on the client i; and λ is a regularization constant.

Optimization goals of federated learning for the clients are defined as follows:

$$arg min {\sum }_{i = 1}^{M} \frac{\vert {D}_{i} \vert}{N} {L}_{S} ( {F}_{i} ( {w}_{i} , {x}_{i} ) , {y}_{i} ) + λ {\sum }_{i = 1}^{M} {\sum }_{j = 1}^{\vert {C}_{i} \vert} \frac{\vert {D}_{i , j} \vert}{{N}_{j}} {L}_{R} ( {C}_{i}^{( j )} {\tilde{- C}}_{i}^{( j )} ) ,$$

where N is total number of samples on the clients; Nⱼ is total number of samples belonging to the class j on the clients; and M is total number of the clients.

The present invention further provides a personalized federated learning system based on similar feature collaboration, characterized in being applied to clients and servers, wherein the server is used to manage at least two clients, each client runs a local model and a local data set for training the local model; and the system comprises a training module, an interaction module, an aggregation module, and a visualization module;

the training module is applied to clients and updates local models thereof by minimizing sums of local classification errors and distances between local class-level feature vector sets and personalized class-level feature vector sets on local data sets of the clients, and updated local class-level feature vector sets are obtained from updated local models;

the interaction module is applied to transmit the local class-level feature vector sets from the clients to the servers, and the servers transmit corresponding personalized local class-level feature vector sets to the clients;

the aggregation module is applied to the servers and calculate distances between the local class-level feature vectors of the clients to obtain aggregation weights for the clients, and based on the aggregation weights, personalized class-level feature vector sets for the clients are generated; and the visualization module visualizes the aggregation weights during a training process to dynamically display and quantitatively evaluate contributions of the clients and changes thereof in contributions.

Compared with the prior art, beneficial effects of the present invention are as follows:

1. By calculating distances between local class-level feature vectors of same classes from different clients, aggregation weights can be derived based on these distances. Then, personalized local class-level feature vectors for each client are obtained based on these aggregation weights. During the local training process at client sides, by minimizing the distances between the local class-level feature vectors and the personalized class-level feature vectors, cooperation among clients with similar class-level feature distributions is promoted, thereby improving the classification performance of local models in heterogeneous data scenarios and enhancing the applicability of local models.

2. Clients interact with servers by using fixed-length feature vectors, which reduces the requirements for local models to have same structures compared to traditional federated learning (FL) that uses all parameters of the local models for interaction, which not only saves communication costs but also improves communication efficiency.

3. By setting up a visualization module, the aggregation weights of clients during the training process can be visualized, allowing for dynamic display and quantitative assessment of the contribution levels of each client's data and their changes over time, which provides a class-level, interpretable reference for evaluating participant contributions in FL and offers insights for incentive payments in federated learning.

### BRIEF DESCRIPTION OF THE DRAWINGS

FIG. 1 is a schematic diagram of an overall framework of a personalized federated learning method and system based on similar feature collaboration.

FIG. 2 is a structural schematic diagram of a local model.

FIG. 3 is a visualization of aggregation weights.

### SPECIFIC EMBODIMENTS

The present invention proposes a personalized federated learning method and system based on collaborative similar features, with the key focus on how to generate personalized class-level aggregation weights. An embodiment is as follows:

### Concept Explanation

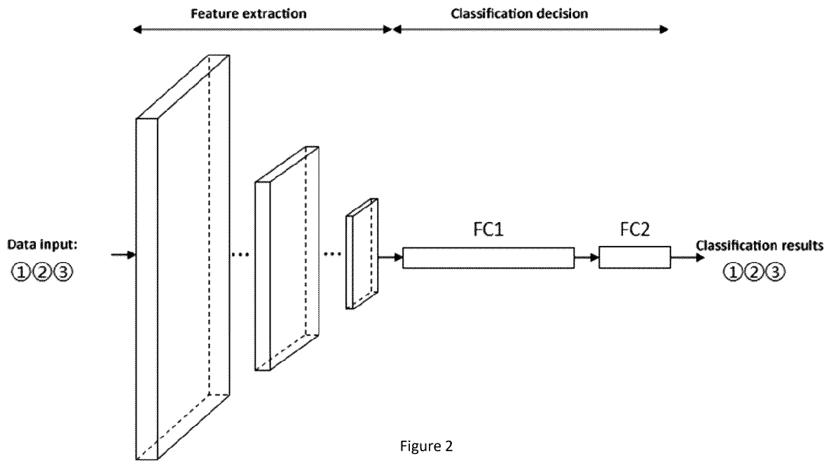

Typically, a classification model comprises a feature extraction part and a classification prediction part. The feature extraction part usually comprises convolutional layers and downsampling, while the classification prediction part generally comprises fully connected layers. As shown in FIG. 2, the output dimension of a last fully connected layer (FC2 in FIG. 2) is the same as the number of classes. Output from a second-to-last fully connected layer (FC1 in FIG. 2) can be taken as the feature vector for a specific class of the client. The selection of the feature vectors can actually be extended; here it is introduced with the present embodiment. If a single client has multiple samples belonging to a same class, feature vectors thereof are averaged to form the feature vector for the class, which is defined as the local class-level feature vector. Thus, there will be as many local class-level feature vectors as there are classes in a client.

If multiple different clients have samples of a same class, assuming that clients A, B, and C all have class 1, the client A is take as an example, the output obtained by aggregating the class 1 local class-level feature vectors of clients A, B, and C with certain weighted rules is referred to as the personalized class-level feature vector of class 1 for client A. Similarly, the personalized class-level feature vectors of class 1 can be obtained for the clients B and C.

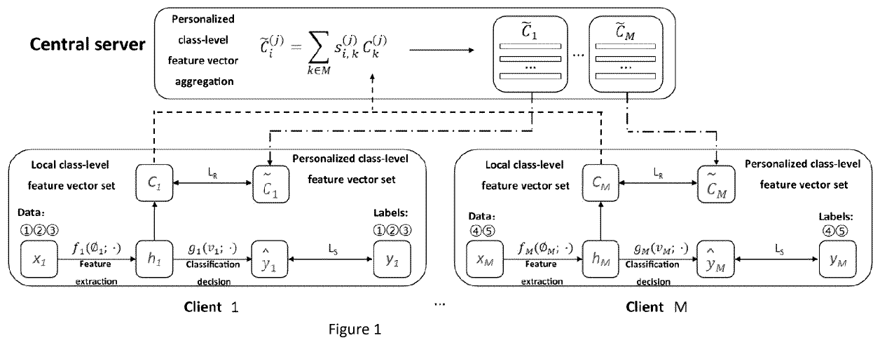

The overall process is illustrated in FIG. 1 and mainly comprises following two key iterative steps:

(1) Client local update: each client downloads corresponding personalized class-level feature vector set from the server and updates local model thereof wᵢ on local data set thereof by minimizing the local training loss Lᵢ (which comprises the classification error L_{S} and the distance L_{R} between the local class-level feature vectors and the personalized class-level feature vectors). Then, each client sends local class-level feature vector set thereof Cᵢ to a central server.

The definition of the local training loss Lᵢ for a client i is as follows:

$${L}_{i} = {L}_{S} ( {F}_{i} ( {w}_{i} , {x}_{i} ) , {y}_{i} ) + λ {\sum }_{j = 1}^{\vert {C}_{i} \vert} \frac{\vert {D}_{i , j} \vert}{{N}_{j}} {L}_{R} ( {C}_{i}^{( j )} - {\tilde{C}}_{i}^{( j )} ) ,$$

where wᵢ is parameter of a local model of client i; xᵢ is an input data; yᵢ is a label corresponding to xᵢ; Fᵢ is classification prediction obtained after xᵢ is input into wᵢ, |Dᵢ| is number of local data of client i; |D_{i,j}| is number of data containing class j in |Dᵢ|; N is total number of samples on the clients; Nⱼ is total number of samples belonging to class j on the clients;

$${C}_{i}^{( j )} and {\tilde{C}}_{i}^{( j )}$$

are local class-level feature vector and personalized class-level feature vector of class j on client i, respectively; |Cᵢ| is number of classes on client i; and λ is regularization constant.

Optimization goals of federated learning for the clients are defined as follows:

$$arg min {\sum }_{i = 1}^{M} \frac{\vert {D}_{i} \vert}{N} {L}_{S} ( {F}_{i} ( {w}_{i} , {x}_{i} ) , {y}_{i} ) + λ {\sum }_{i = 1}^{M} {\sum }_{j = 1}^{\vert {C}_{i} \vert} \frac{\vert {D}_{i , j} \vert}{{N}_{j}} {L}_{R} ( {C}_{i}^{( j )} - {\tilde{C}}_{i}^{( j )} ) ,$$

where N is total number of samples on the clients; Nⱼ is total number of samples belonging to class j on the clients; M is total number of the clients, and the explanations of the remaining parameters are the same as above.

(2) Server class-level feature aggregation: the central server generates personalized class-level feature vectors for each client based on the aggregation weights and returns them to the corresponding clients to promote collaboration between similar clients.

Take class j on client i as an example, a method for calculating the aggregation weight is given. First, the distance between

$${C}_{i}^{( j )}$$

and the local class-level feature vectors

$${C}_{k}^{( j )}$$

on other clients containing class j is calculated (using vector distance calculation methods such as Euclidean distance, Manhattan distance, and angle cosine distance). That is:

A formula for calculating the Euclidean distance is

$${dist}_{i , k}^{( j )} = \sqrt{{( {C}_{i}^{( j )} - {C}_{k}^{( j )} )}^{2}} , where k ∈ [ 1 , {M}^{( j )} ] ;$$

a formula for calculating the Manhattan distance is

$${dist}_{i , k}^{( j )} = \vert {C}_{i}^{( j )} - {C}_{k}^{( j )} \vert , where k ∈ [ 1 , {M}^{( j )} ] ;$$

and
a formula for calculating the angle cosine distance is

$${dist}_{i , k}^{( j )} = \frac{〈 {C}_{i}^{( j )} , {C}_{k}^{( j )} 〉}{\vert {C}_{i}^{( j )} \vert \vert {C}_{k}^{( j )} \vert} ,$$

where k∈[1,M^{(j)})], i, k represents the client number, M^{(j)} represents the number of clients with class j, then the distance vector is calculated as follows:

$$\begin{matrix}{dist}_{i}^{( j )} = [ {dist}_{i , 1}^{( j )} , … , {dist}_{i , i}^{( j )} , … , {dist}_{i , {M}^{( j )}}^{( j )} ] , where : j ∈ [ 1 , \vert {C}_{i} \vert ] , \\ {dist}_{i , i}^{( j )}\end{matrix}$$

is set to a constant, in view that the smaller the value, the closer the features are, the greater the aggregation weight will be. Therefore, by taking the inverse proportion of the distance and normalizing it, the weight vector is obtained, that is

$${S}_{i}^{( j )} = [ {s}_{i , 1}^{( j )} , … , {s}_{i , i}^{( j )} , … , {s}_{i , {M}^{( j )}}^{( j )} ] , where {s}_{i , k}^{( j )}$$

represents an aggregate weight of a client k for the class j of the client i, and

$${\sum }_{k = 1}^{{M}^{( j )}} {s}_{i , k}^{( j )} = 1 ;$$

then the personalized feature vector of the class j on the client i is

$${\tilde{C}}_{i}^{( j )} = {[ {s}_{i , 1}^{( j )} , … , {s}_{i , i}^{( j )} , … , {s}_{i , {M}^{( j )}}^{( j )} ] [ {C}_{1}^{( j )} , … , {C}_{i}^{( j )} , … , {C}_{{M}^{( j )}}^{( j )} ]}^{T} = {\sum }_{k ∈ {M}^{( j )}} {s}_{i , k}^{( j )} {C}_{k}^{( j )} .$$

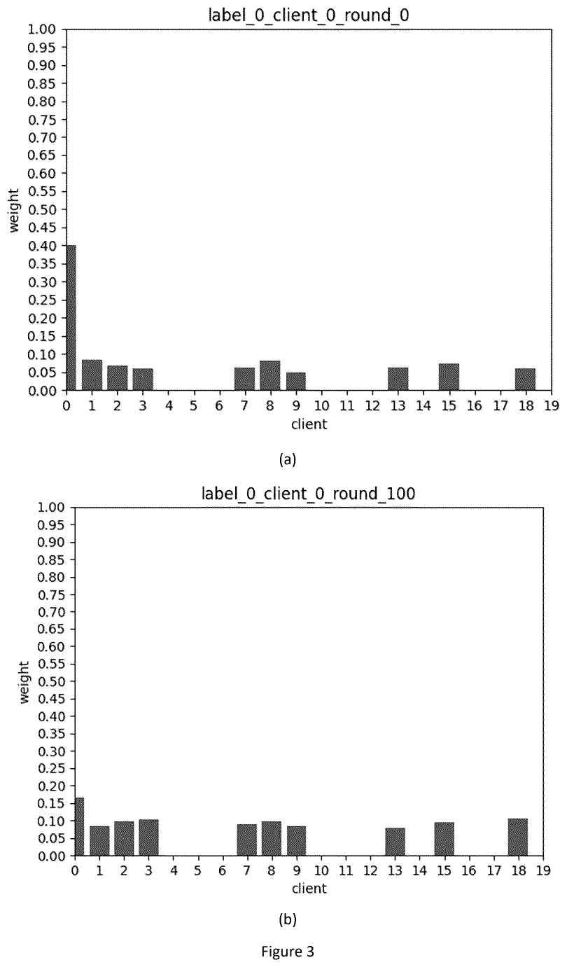

Aggregation weights can serve as references for evaluating the contributions of clients during training. FIG. 3 shows serial numbers of clients on a horizontal axis and aggregation weights on a vertical axis. Figures (a) and (b) in FIG. 3 respectively represent the aggregate weight distribution of the personalized feature vectors of category 1 (label_0) on client 1 (client_0) after the 1st and 101st rounds of communication (round_0 and round_100). FIG. 3 shows that after the first round, client 1 accounts for 0.40 and client 19 (client_18) accounts for 0.06. After the 101st round, client 1 accounts for 0.16 and client 19 accounts for 0.11. As the number of communication rounds increases, the client's own weight decreases while the weights of other clients increase. The weight differences among these clients are relatively small, indicating that the feature vectors for this class on these clients are relatively close, resulting in a mutually beneficial outcome through collaboration. Furthermore, by monitoring the incremental weights of other clients relative to the current client, it is possible to determine whether further communication and collaboration are necessary.

The embodiments described above provide a detailed description of the technical solutions and beneficial effects of the present invention. It should be understood that the above are only specific embodiments of the present invention and are not intended to limit the present invention. Any modifications, supplements and equivalent substitutions made within the scope of the principles of the present invention should be included in the scope of protection of the present invention.

1. A personalized federated learning method based on similar feature collaboration, for application on clients and servers, wherein each of the servers is used to manage at least two of the clients, and each of the clients runs a local model and a local data set for training the local model; and the method comprises:
(1) the servers initialize and receive local class-level feature vector sets sent by the clients;
(2) the servers generate personalized class-level feature vector sets for the clients based on aggregation weights of the clients according to the local class-level feature vector sets sent by the clients;
(3) the clients download corresponding personalized class-level feature vector sets from the servers, and update local models thereof on local data sets thereof by minimizing sums of local classification errors and distances between the local class-level feature vector sets and the personalized class-level feature vector sets; and updated local models obtain updated local class-level feature vector sets and send to the servers; and
(4) the steps (2) to (3) are repeated until average training losses of the clients no longer decrease.

2. The personalized federated learning method based on similar feature collaboration according to claim 1, wherein a local data set on one of the clients is input into a local models thereof, output of one fully connected layers responsible for decision-making in a back end of classification network is used as a feature vector of a class of the client, and feature vectors of all data samples belonging to the class are averaged to obtain a local class-level feature vector of the class.

3. The personalized federated learning method based on similar feature collaboration according to claim 2, wherein output sizes of fully connected layers where the clients extract local class-level feature vectors are same.

4. The personalized federated learning method based on similar feature collaboration according to claim 1, wherein on the servers, the local class-level feature vectors of the clients with samples of same classes are aggregated based on aggregation weights of the clients to obtain personalized class-level feature vectors for the clients.

5. The personalized federated learning method based on similar feature collaboration according to claim 1, wherein the step (2) comprises:
(i) for a client i, calculating distances between a local class-level feature vector
$${C}_{i}^{( j )}$$
of a class j and local class-level feature vectors
$${C}_{k}^{( j )}$$
on other clients containing the class j,
$${dist}_{i , k}^{( j )} , k ∈ [ 1 , {M}^{( j )} ] ,$$
and obtaining a distance vector
$${dist}_{i}^{( j )} = [ {dist}_{i , 1}^{( j )} , … , {dist}_{i , i}^{( j )} , … , {dist}_{i , {M}^{( j )}}^{( j )} ] , where j ∈ [ 1 , \vert {C}_{i} \vert ] , \vert {C}_{i} \vert$$
is number of classes on the client i, M^{(j)} represents number of clients containing the class j; and
$${dist}_{i , i}^{( j )}$$
is set to a constant;
(ii) for a distance vector
$${dist}_{i}^{( j )} ,$$
taking an inverse ratio of the distances
$${dist}_{i , k}^{( j )}$$
and normalizing to obtain a weight vector
$${S}_{i}^{( j )} = [ {s}_{i , 1}^{( j )} , … , {s}_{i , i}^{( j )} , … , {s}_{i , {M}^{( j )}}^{( j )} ] , where {s}_{i , k}^{( j )}$$
represents an aggregate weight of a client k for the class j of the client i, and
$${\sum }_{k = 1}^{{M}^{( j )}} {s}_{i , k}^{( j )} = 1 ;$$
and
(iii) calculating a personalized class-level feature vector
$${\tilde{C}}_{i}^{( j )}$$
for the class j on the client i via following calculation formula:
$${\tilde{C}}_{i}^{( j )} = {[ {s}_{i , 1}^{( j )} , … , {s}_{i , i}^{( j )} , … , {s}_{i , {M}^{( j )}}^{( j )} ] [ {C}_{1}^{( j )} , … , {C}_{i}^{( j )} , … , {C}_{{M}^{( j )}}^{( j )} ]}^{T} = {\sum }_{k ∈ {M}^{( j )}} {s}_{i , k}^{( j )} {C}_{k}^{( j )} .$$

6. The personalized federated learning method based on similar feature collaboration according to claim 5, wherein in the step (i), the distances
$${dist}_{i , k}^{( j )}$$
comprises Euclidean distances, Manhattan distances, and angle cosine distances.

7. The personalized federated learning method based on similar feature collaboration according to claim 6, wherein
a formula for calculating the Euclidean distance is:
$$\begin{matrix}{dist}_{i , k}^{( j )} = \sqrt{{( {C}_{i}^{( j )} - {C}_{k}^{( j )} )}^{2}} , where \\ k ∈ [ 1 , {M}^{( j )} ] ;\end{matrix}$$
a formula for calculating the Manhattan distances is
$$\begin{matrix}{dist}_{i , k}^{( j )} = \vert {C}_{i}^{( j )} - {C}_{k}^{( j )} \vert , where \\ k ∈ [ 1 , {M}^{( j )} ] ;\end{matrix}$$
and
a formula for calculating the angle cosine distances is
$$\begin{matrix}{dist}_{i , k}^{( j )} = \frac{〈 {C}_{i}^{( j )} \cdot {C}_{k}^{( j )} 〉}{\vert {C}_{i}^{( j )} \vert \vert {C}_{k}^{( j )} \vert} , where \\ k ∈ [ 1 , {M}^{( j )} ] .\end{matrix}$$

8. The personalized federated learning method based on similar feature collaboration according to claim 1, wherein in the step (3), a local training loss Lᵢ of a client i is defined as follow:
$${L}_{i} = {L}_{S} ( {F}_{i} ( {w}_{i} , {x}_{i} ) , {y}_{i} ) + λ {\sum }_{j = 1}^{\vert {C}_{i} \vert} \frac{\vert {D}_{i , j} \vert}{{N}_{j}} {L}_{R} ( {C}_{i}^{( j )} - {\tilde{C}}_{i}^{( j )} ) ,$$
where wᵢ is parameter of a local model of the client i, xᵢ is input data; yᵢ is a label corresponding to xᵢ; Fᵢ is classification prediction obtained after xᵢ is input into the local model; |Dᵢ| is number of local data of the client i; |D_{i,j}| is number of data containing a class j in the local data; N is total number of samples on the clients; Nⱼ is total number of samples belonging to the class j on the clients;
$${C}_{i}^{( j )} and {\tilde{C}}_{i}^{( j )}$$
are local class-level feature vector and personalized class-level feature vector of the class j on the client i, respectively; |Cᵢ| is number of classes on the client i; and λ is regularization constant.

9. The personalized federated learning method based on similar feature collaboration according to claim 1, wherein optimization goals of federated learning for the clients are defined as follows:
$$arg min {\sum }_{i = 1}^{M} \frac{\vert {D}_{i} \vert}{N} {L}_{S} ( {F}_{i} ( {w}_{i} , {x}_{i} ) , {y}_{i} ) + λ {\sum }_{i = 1}^{M} {\sum }_{j = 1}^{\vert {C}_{i} \vert} \frac{\vert {D}_{i , j} \vert}{{N}_{j}} {L}_{R} ( {C}_{i}^{( j )} - {\tilde{C}}_{i}^{( j )} ) ,$$
where is total number of samples on the clients; Nⱼ is total number of N samples belonging to a class j on the clients; M is total number of the clients.

10. A personalized federated learning system based on similar feature collaboration, characterized in being applied to clients and servers, wherein each of the servers is used to manage at least two clients, each client runs a local model and a local data set for training the local model; the system comprises a training module, an interaction module, an aggregation module, and a visualization module;
the training module is applied to the clients and updates local models thereof by minimizing sums of local classification errors and distances between local class-level feature vector sets and personalized class-level feature vector sets on local data sets of the clients, and updated local class-level feature vector sets are obtained from updated local models;
the interaction module is applied to transmit the local class-level feature vector sets from the clients to the servers, and the servers transmit corresponding personalized local class-level feature vector sets to the clients;
the aggregation module is applied to the servers and calculate distances between the local class-level feature vectors of the clients to obtain aggregation weights for the clients, based on the aggregation weights, personalized class-level feature vector sets for the clients are generated; and
the visualization module visualizes the aggregation weights during a training process to dynamically display and quantitatively evaluate contributions of the clients and changes thereof in contributions.
